(19) United States
(12) Patent Application Publication
(10) Pub. No.: US 2024/0390211 A1
(43) Pub. Date: Nov. 28, 2024

(54) WEIGHT-SUPPORTED WALKING ASSIST APPARATUS AND METHOD FOR CONTROLLING THE SAME

(71) Applicant: CYBERDYNE INC., Tsukuba-shi, Ibaraki (JP)

(72) Inventors: Yoshiyuki SANKAI, Tsukuba-shi, Ibaraki (JP); Kota TAMAI, Tsukuba-shi, Ibaraki (JP)

(73) Assignee: CYBERDYNE INC., Tsukuba-shi, Ibaraki (JP)

(21) Appl. No.: 18/694,097

(22) PCT Filed: Jul. 28, 2022
(86) PCT No.: PCT/JP2022/029215

§ 371 Date: Mar. 21, 2024

(30) Foreign Application Priority Data
Sep. 21, 2021 (JP) 2021-153401

(51) Int. Cl. A61H 3/00

(52) U.S. Cl. CPC A61H 3/00; A61H 2201/1215; A61H 2201/1633; A61H 2201/1642; A61H 2201/165; A61H 2201/1676; A61H 2201/5061

(57) ABSTRACT

When a wearer who wears a weight-supported walking assist apparatus performs walking motions in a state with their buttocks supported by a seat unit, bending of the wearer's knee joint part is limited to a specified range upon a transition from a swing phase to a stance phase; and on the other hand, upon a transition from the stance phase to the swing phase, the wearer's knee joint part can bend or extend and, at the same time, motive power is given according to the wearer's intention.

### TECHNICAL FIELD

The present invention relates to a weight-supported walking assist apparatus and a method for controlling the same and is particularly suited for application to a weight-supported walking assist apparatus and a method for controlling the same for knee osteoarthritis patients.

### BACKGROUND ART

In recent years, our country has entered the aging society and degenerative diseases based on changes caused by aging are definitely increasing, and osteoarthritis is one of the most common diseases among orthopedic diseases. Of such diseases, knee osteoarthritis is caused by abrasion of knee cartilage mainly along with the aging, symptoms such as pain, inflammation, and contracture of a knee joint(s) occurs and deformation of the knee joint(s) gradually progresses, which may result in a gait disorder, so that it will degrade QOL (Quality of Life) significantly.

In order to suppress or improve the progress of the knee osteoarthritis, it is said that correction of the deformation is effective; however, sufficient self-healing may not be achieved in many cases and eventually surgery is conducted. On the other hand, there is a demand for the development of a new method which does not involve any invasion into a human body because surgeries for, for example, high tibial osteotomy and artificial joint replacement have high risk due to complications and cause high mental and physical burdens.

In recently years, there has been a development in regenerative medicine for transplanting cultured tissues with human cells cultivated therein to a lesioned part. It is possible to treat a patient who suffers from the knee osteoarthritis, while externally injecting, for example, stem cells into an internal space of the patient's knee joint part and thereby causing cartilage cells to be regenerated.

There is proposed, from the present invention, a knee joint corrective tool manufacturing apparatus and a knee joint corrective tool manufacturing method which are capable of promoting noninvasive natural treatment and regenerative cell therapy in daily life after applying the above-described treatment of the regenerative medicine to the knee joint part (see PTL 1).

### CITATION LIST

### Patent Literature

PTL 1: WO 2018/051898

### SUMMARY OF THE INVENTION

### Problems to be Solved by the Invention

Meanwhile, during a period of time when the cartilage cells are transplanted to the knee joint part and then the cartilage of the damaged knee joint part integrates with the transplanted cartilage, it is necessary to reduce burden on the knee joint. Particularly because the body weight of the patient themselves is imposed on the knee joint part, it is desirable that the body weight should not be imposed on the knee joint part as much as possible when the patient walks after the treatment.

The present invention was devised in consideration of the above-described circumstance and proposes a weight-supported walking assist apparatus and a method for controlling the same which are capable of remarkably reducing the weight burden imposed on the knee joint part and assisting motions when the wearer performs walking motions.

### Means to Solve the Problems

In order to solve the above-described problem, a weight-supported walking assist apparatus according to the present invention includes: a seat unit that supports buttocks of a wearer; a thigh frame and a lower leg frame that are located along inside of a leg part of the wearer; a hip joint connector that couples an underside of the seat unit with one end of the thigh frame and is rotatable in accordance with motions of a hip joint part of the wearer; a rotary drive unit that is provided in the hip joint connector and drives the thigh frame relative to the seat unit in a rotation direction of the hip joint part; a knee joint connector that couples another end of the thigh frame with one end of the lower leg frame and is rotatable in accordance with motions of a knee joint part of the wearer; a lock mechanism unit for locking or releasing a rotary state of the knee joint connector; shoe units that are for right and left foot parts of the wearer to wear and either one of which is joined to another end of the lower leg frame; a ground reaction force sensor that is attached to each of the right and left shoe units and detects pressure distribution to each foot sole surface of the wearer; a biosignal detection unit that is attached to a thigh part of the wearer on a side where the thigh frame is located, and detects a biosignal caused by walking motions of the wearer; a gait synchronization calculation unit that calculates a gait cycle of the wearer based on a detection result of the ground reaction force sensor; and a control unit that locks a rotary state of the lock mechanism unit in a bending direction so as to limit bending of the knee joint part of the wearer to a specified range upon a transition from a swing phase to a stance phase of the walking motions on the basis of a calculation result of the gait synchronization calculation unit, while releasing the lock mechanism unit so that the knee joint part of the wearer can bend or extend upon a transition from the stance phase to the swing phase, wherein the control unit causes the rotary drive unit to generate motive power according to the wearer's intention upon the transition from the stance phase to the swing phase on the basis of a detection result of the biosignal detection unit.

Accordingly, when the wearer who wears the weight-supported walking assist apparatus performs the walking motions in a state with their buttocks supported by the seat unit, bending of the wearer's knee joint part is limited to the specified range upon the transition from the swing phase to the stance phase of the walking motions; and on the other hand, upon the transition from the stance phase to the swing phase, the wearer's knee joint part can bend or extend and, at the same time, the motive power is given according to the wearer's intention, so that during the stance phase of the walking motions, the motions can be assisted by reducing the ground reaction force and thereby reducing load on the knee joint part imposed by the wearer's own weight.

Moreover, according to the present invention, the control unit is designed to adjust a fixed range of the rotary state of the lock mechanism unit so that a load amount on to the knee joint part of the wearer will increase in accordance with a transition state in a corrective direction in order to improve symptoms of the knee joint part of the wearer.

As a result, the wearer can adjust a slightly bent state of the knee joint part to support the body weight during the stance phase of the walking motions, so that the weight burden on the knee joint part can be adjusted and reduced to an optimum state.

Furthermore, according to the present invention, the weight-supported walking assist apparatus further includes a seat surface reaction force sensor that is mounted in the seat unit and detects pressure distribution to the buttocks of the wearer, wherein the control unit is designed to control the rotation drive unit so that the shoe unit will not contact a walking surface during the swing phase of the walking motions on the basis of the detection result of the biosignal detection unit and the detection result of the seat surface reaction force sensor.

As a result, the weight-supported walking assist apparatus can assist the motions while adjusting the weight burden imposed on the knee joint part by the wearer's own weight to the optimum state with high accuracy by reducing the ground reaction force during the stance phase of the walking motions on the basis of not only the pressure distribution to the wearer's foot sole parts, but also the pressure distribution to the wearer's buttocks.

Furthermore, regarding a method for controlling a weight-supported walking assist apparatus according to the present invention, while buttocks of the wearer are supported by a seat unit, a thigh frame and a lower leg frame are located along inside of a leg part of the wearer, shoe units either one of which is joined to another end of the lower leg frame are mounted to right and left foot parts of the wearer, and furthermore a hip joint connector that couples an underside of the seat unit with one end of the thigh frame is made rotatable in accordance with motions of a hip joint part of the wearer and a knee joint connector that couples another end of the thigh frame with one end of the lower leg frame is made rotatable in accordance with motions of a knee joint part of the wearer; and the hip joint connector is provided with a rotary drive unit that drives the thigh frame relative to the seat unit in a rotation direction of the hip joint part and a lock mechanism unit for locking or releasing a rotary state of the knee joint connector is provided, wherein the method for controlling the weight-supported walking assist apparatus includes: a first step of detecting pressure distribution to respective foot sole parts of the wearer at the right and left shoe units; a second step of calculating a gait cycle of the wearer based on a detection result of the first step; a third step of locking a rotary state of the lock mechanism unit in a bending direction so as to limit bending of the knee joint part of the wearer to a specified range upon a transition from a swing phase to a stance phase of walking motions on the basis of a calculation result of the second step, while releasing the lock mechanism unit so that the knee joint part of the wearer can bend or extend upon a transition from the stance phase to the swing phase; a fourth step of detecting a biosignal caused by the walking motions of the wearer at a thigh part of the wearer on a side where the thigh frame is located; and a fifth step of causing the rotary drive unit to generate motive power according to the wearer's intention upon a transition from the stance phase to the swing phase in the third step on the basis of a detection result of the fourth step.

Accordingly, when the wearer who wears the weight-supported walking assist apparatus performs the walking motions in a state with their buttocks supported by the seat unit, bending of the wearer's knee joint part is limited to the specified range upon the transition from the swing phase to the stance phase; and on the other hand, upon the transition from the stance phase to the swing phase, the wearer's knee joint part can bend or extend and, at the same time, the motive power is given according to the wearer's intention, so that during the stance phase of the walking motions, the motions can be assisted by reducing the ground reaction force and thereby reducing load on the knee joint part imposed by the wearer's own weight.

### Advantageous Effects of the Invention

When the wearer performs the walking motions, the weight-supported walking assist apparatus and the method for controlling the same, which are capable of assisting the motions while remarkably reducing the weight burden imposed on the knee joint part can be implemented according to the present invention.

### BRIEF DESCRIPTION OF DRAWINGS

FIG. 1 is a conceptual diagram illustrating the configuration of a weight-supported walking assist apparatus according to this embodiment;

FIG. 2 is an exploded view illustrating the configuration of a drive unit for the weight-supported walking assist apparatus illustrated in FIG. 1;

FIG. 3 is a perspective view illustrating an appearance configuration of a knee joint connector illustrated in FIG. 1;

FIG. 4 is a block diagram illustrating the configuration of a control system for the weight-supported walking assist apparatus illustrated in FIG. 1;

FIGS. 5(A)-5(C) are schematic diagrams for explaining an operating status of the knee joint connector illustrated in FIG. 3;

FIG. 6 is a schematic diagram for explaining walking motions by a wearer who wears the weight-supported walking assist apparatus;

FIG. 7 is a schematic diagram for explaining the walking motions by the wearer who wears the weight-supported walking assist apparatus;

FIG. 8 is a schematic diagram for explaining the walking motions by the wearer who wears the weight-supported walking assist apparatus;

FIG. 9 is a graph and chart for explaining a weight-supported assist function;

FIG. 10 is a graph and chart for explaining the weight-supported assist function;

FIG. 11 is a graph and chart for explaining the weight-supported assist function;

FIG. 12 is a conceptual diagram illustrating the configuration of a weight-supported walking assist apparatus according to another embodiment;

FIGS. 13(A) and 13(B) are conceptual diagrams illustrating an appearance configuration and an internal structure of a knee joint connector illustrated in FIG. 12;

FIGS. 14(A) and 14(B) are conceptual diagrams illustrating an internal structure of the knee joint connector illustrated in FIG. 12;

FIGS. 15(A) and 15(B) are conceptual diagrams illustrating an internal structure of the knee joint connector illustrated in FIG. 12;

FIG. 16 is a graph and chart for explaining the weight-supported assist function; and

FIGS. 17(A) and 17(B) are graphs and charts for explaining the weight-supported assist function.

### DESCRIPTION OF EMBODIMENTS

An embodiment of the present invention will be described below in detail with reference to the drawings.

### (1) Configuration of Weight-Supported Walking Assist Apparatus According to the Present Invention

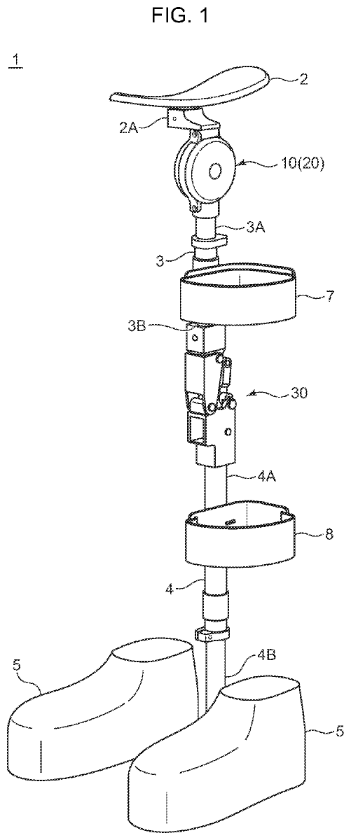

FIG. 1 illustrates a weight-supported walking assist apparatus 1 according to this embodiment, which has a seat unit 2 supporting a wearer's buttocks, a thigh frame 3 and a lower leg frame 4 which are located along inside of the wearer's leg, and shoe units 5 which are attached to the wearer's right and left foot parts and either of which is joined to the other end 4B of the lower leg frame 4.

The thigh frame 3 and the lower leg frame 4 have a frame body formed in an elongated plate shape made of, for example, a metal such as stainless steel, carbon fibers (carbon fibers), or the like and are made to be lightweight and have high rigidity.

A hip joint connector 10 which is rotatable according to motions of the wearer's hip joint part is connected between a seat clamp 2A fixed on an underside of the seat unit 2 and one end 3A of the thigh frame 3. This hip joint connector 10 has a drive unit (a rotary drive unit) 20 for driving the thigh frame 3 in a rotation direction of the hip joint part relative to the seat unit 2.

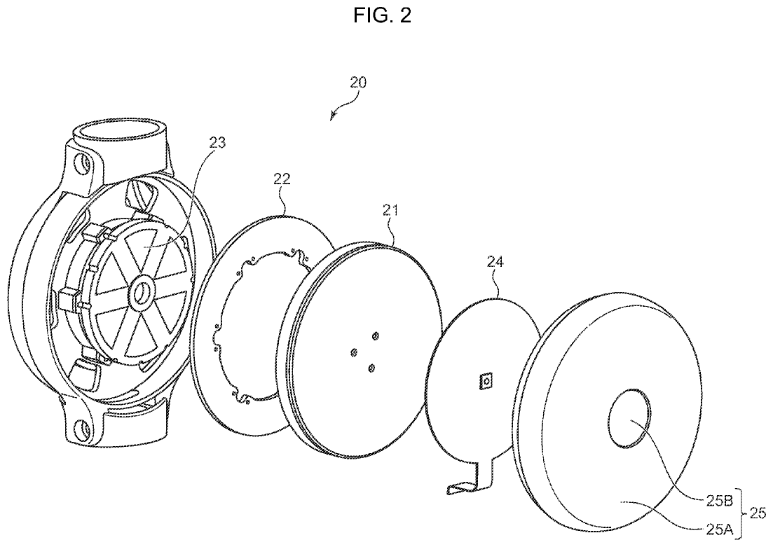

As illustrated in FIG. 2, the drive unit 20 has a flat-type actuator 21 consisting of, for example, a brushless DC motor, an actuator control unit 22 for driving and controlling the actuator 21, and a decelerator 23 for converting a rotation speed of a rotator of the actuator 21 to a specified deceleration rate and outputting the converted speed. The actuator control unit 22 has a built-in MCM (Multi-Chip Module) in which a CPU (Central Processing Unit), a memory, and so on are mounted.

An operation unit 25 is configured from a touch panel 25A constituting a surface of a housing and a power button 25B in the center of the housing, the operation content to the touch panel 25A by the wearer's fingertip contact is reflected in the actuator control unit 22 as a detection result of a touch sensor 24, and the power is turned on or off in response to pressing down of the power button 25B.

In the drive unit 20, a main body of the decelerator 23 and the actuator control unit 22 are housed in substantially the same plane in the seat clamp 2A fixed on the underside of the seat unit 2, and an output axis of the decelerator 23 is fixed to one end 3A of the thigh frame 3.

Moreover, a knee joint connector 30 which is rotatable according to motions of the wearer's knee joint part is connected between the other end 3B of the thigh frame 3 and one end 4A of the lower leg frame 4.

The knee joint connector 30 has a closed-loop structure consisting of a four-link mechanism of a fixed link, a driver, a follower, and an intermediate link, and the follower is made to rotate via the intermediate link according to rotations of the driver with reference to the fixed link.

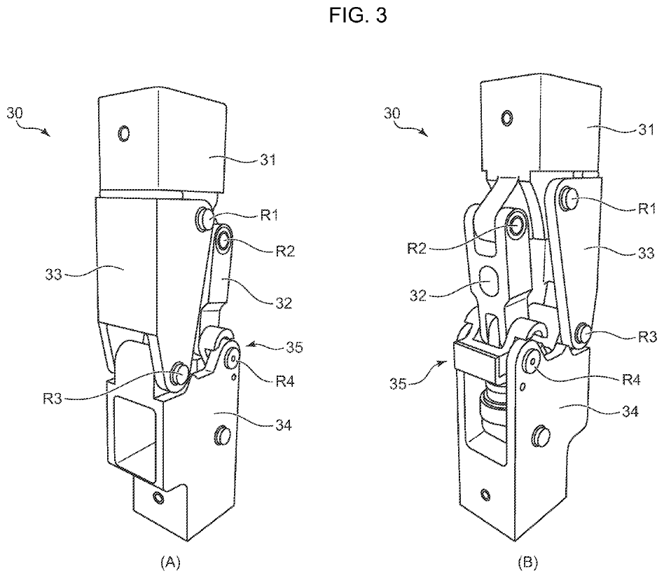

As illustrated in FIG. 3(A) and FIG. 3(B), a thigh-side link unit 31 connected to the other end 3B of the thigh frame 3 is provided with rotation axes R1 and R2 on the center and rear sides respectively to form a fixed link, one end 33A of a bending link unit 32 which is a driver is connected to the rear rotation axis R1, and one end 33A of a patella link unit 33 which is a follower is connected to the center rotation axis R2.

The lower-leg-side link unit 34 connected to one end 4A of the lower leg frame 4 is provided with rotation axes R3 and R4 on the front and rear sides, respectively, to form an intermediate link, the other end 33B of the patella link unit 33 is connected to the front rotation axis R3, and the other end 32B of the bending link unit 32 is connected to the rear rotation axis R4.

In the knee joint connector 30, a connection site between one end 4A of the lower leg frame 4 and the other end 32B of the bending link unit 32 is provided with a lock mechanism unit 35 centered at a corresponding rotation axis R5, and a rotating state of the lower leg frame 4 and the bending link unit 32 is locked or released according to the operation of an electromagnetic solenoid.

Incidentally, each of the thigh frame 3 and the lower leg frame 4 has a built-in adjustment mechanism unit (which is not illustrated in the drawing) for adjusting its frame length in a stretchable manner.

Referring to FIG. 1, the shoe unit(s) 5 attached to the wearer's foot part(s), which is an object to be treated, is connected to the other end 4B of the lower leg frame 4. The shoe unit 5 has a short shoe wrapping the wearer's foot part and a fixed fastening unit (which is not illustrated in the drawing) consisting of a metal component which is relatively highly rigid and is joined to an inside surface of the short shoe.

Cuffs 7 and 8 are attached to the thigh frame 3 and the lower leg frame 4, respectively (FIG. 1), so that they wrap around the wearer's thigh part and lower leg part, respectively, and fasten them firmly.

Accordingly, with the weight-supported walking assist apparatus 1, when the wearer performs the walking motions with their buttocks supported by the seat unit 2, it becomes possible to reduce the load on the knee joint part, which is imposed by the wearer's own weight, during the stance phase of the walking motions.

### (2) Internal System Configuration of Weight-Supported Walking Assist Apparatus

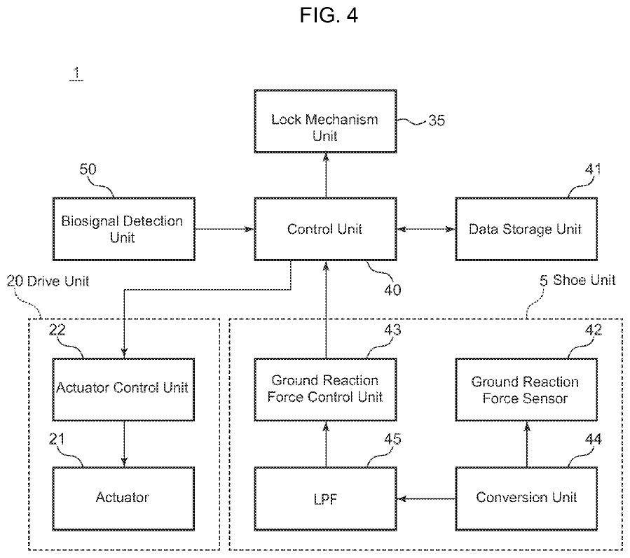

FIG. 4 illustrates the configuration of a control system for the weight-supported walking assist apparatus 1 according to this embodiment. The control system has a control unit 40 for implementing overall control of the entire system and a data storage unit 41.

The soles of the right and left shoe units 5 are provided with an insole-type ground reaction force sensor 42 to detect a reaction force (pressure distribution to the foot sole parts) against the load applied to the wearer's foot sole surface. The ground reaction force sensor 42 can divide the load applied to the foot sole surface into a front foot part (toe part) and a rear foot part (heel part) and measure the divided loads independently.

This ground reaction force sensor 42 consisting of, for example, a piezoelectric element that outputs a voltage according to the applied load or a sensor whose static capacitance changes according to the load and can detect load changes associated with weight movements and whether the wearer's leg is in contact with the ground or not, respectively.

The shoe unit 5 has a ground reaction force control unit 43 consisting of a ground reaction force sensor 42 and an MCU (Micro Control Unit) other than the shoe structure. After the output of the ground reaction force sensor 42 is converted into voltage via a conversion unit 44, a high-frequency band is cut off via an LPF (Low Pass Filter) 45 and the obtained voltage is then input to the ground reaction force control unit 43.

Based on the detection result of the ground reaction force sensor 42, this ground reaction force control unit 43 checks whether or not any load change or any contact with the ground has been caused by the wearer's weight movements, and sends the result as ground reaction force data to the control unit 40. The control unit 40 stores the received ground reaction force data in a reference parameter database of the data storage unit 41.

The control unit 40 as a walking synchronization calculation unit calculates the wearer's gait cycle on the basis of the detection result of the ground reaction force sensor 42. Specifically, the control unit 40 identifies the relevant phase of the wearer's walking motions by comparing a load transition state relating to the foot soles based on the ground reaction force data and a load transition state of reference parameters stored in the reference parameter database of the data storage unit 41.

The control unit 40 captures the identified phase of the walking motions by dividing the walking state into a swing phase and a stance phase. The swing phase is a phase of movement in which a foot leaves the ground and swings out the lower leg. The stance phase is a phase in which the foot contacts the ground and supports the wearer's own weight.

Since the wearer lands the ground on the rear foot part (heel part) of the foot part during walking, the ground reaction force on the rear foot part side increases in advance of the ground reaction force on the front foot part side (toe part side). When the foot part leaves the ground, the rear foot part of the foot part leaves the ground first and then the front foot part leaves the ground. So, the ground reaction force on the front foot part side decreases after the ground reaction force on the rear foot part side.

By using these, the control unit 40 judges the relevant phase based on information about the ground reaction force on the front foot part side and the ground reaction force on the rear foot part side (ground reaction force data representing the load) in the shoe sole part. When the ground reaction force on the rear foot part side increases, it is determined that the swing phase switches to the stance phase; and when the ground reaction force on the front foot part side decreases, it is determined that the stance phase switches to the swing phase.

Furthermore, the control unit 40 locks or releases the rotational state of the lower-leg-side link unit 34 and the bending link unit 32 by controlling the electromagnetic solenoid of the lock mechanism unit 35 on the basis of the calculation result of walking synchronization.

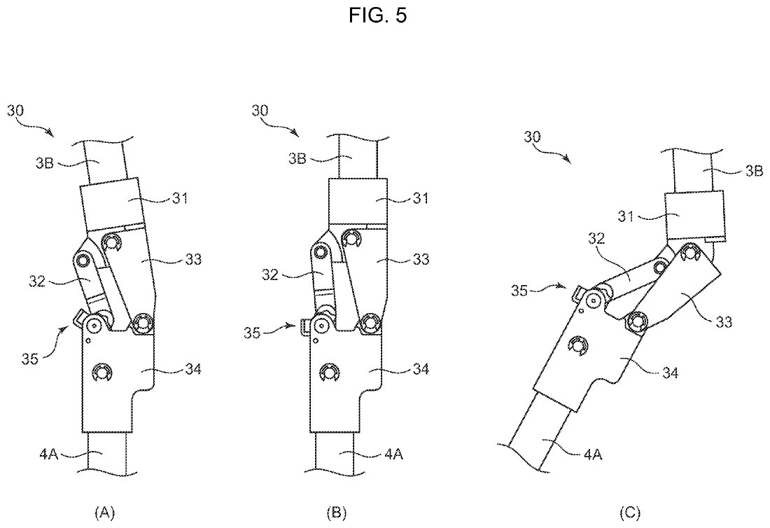

Practically, in the knee joint connector 30, the control unit 40 controls the lock mechanism unit 35 and locks the rotary state of the bending link unit 32 in the bending direction with respect to the lower-leg-side link unit 34 to limit the bending of the wearer's knee joint part to a specified range (FIG. 5(A)).

Then, the control unit 40 controls the lock mechanism unit 35 and releases the rotary state of the bending link unit 32 in the bending direction with respect to the lower-leg-side link unit 34 (FIG. 5(B)). When the lock mechanism unit 35 is released in the knee joint connector 30, the bending link unit 32, the patella link unit 33, and the lower-leg-side link unit 34 become rotatable relative to the thigh-side link unit 31 so that the wearer's knee joint part can bend or extend (FIG. 5(C)).

With the weight-supported walking assist apparatus 1, a biosignal detection unit 50 (FIG. 4) is attached to the wearer's thigh part on the side where the thigh frame is located to detect a biosignal caused by the wearer's walking motions.

Moreover, the control unit 40 causes the drive unit (rotary drive unit) 20 to generate motive power according to the wearer's intention upon the transition from the stance phase to the swing phase on the basis of the detection result of the biosignal detection unit 50. The actuator control unit 22 of the drive unit 20 can transmit a driving torque of the actuator 21 according to movements of the wearer's hip joint as an assist force to the hip joint by driving and controlling the actuator 21 based on the detection result of the biosignal detection unit 50 sent from the control unit 40.

### (3) Walking Motions by Wearer Who Wears Weight-Supported Walking Assist Apparatus

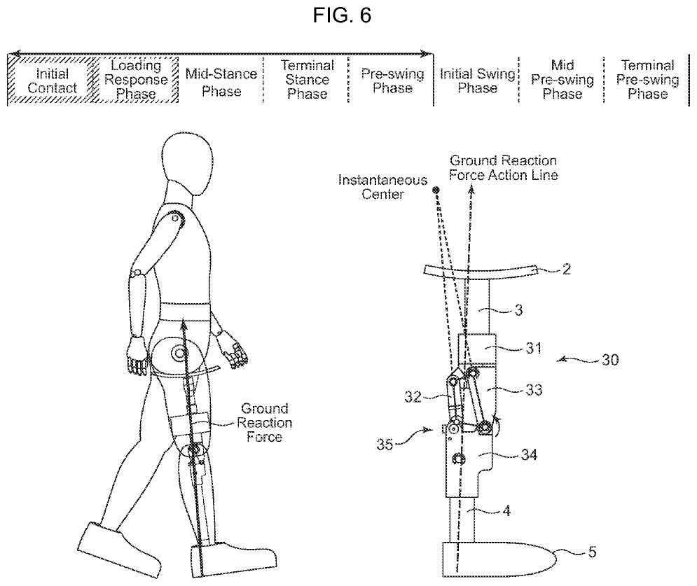

Regarding the above-described configuration, with the weight-supported walking assist apparatus 1 according to this embodiment, when the wearer performs the walking motions with their buttocks supported by the seat unit 2, the control unit 40 locks the lock mechanism unit 35 of the knee joint connector 30 in a beginning part of the stance phase of the walking motions (from an initial contact to a loading response phase) (FIG. 6).

As illustrated in FIG. 6, the lock mechanism unit 35 of the knee joint connector 30 is locked so that a line of action F1 of the ground reaction force obtained from the foot sole surface of the wearer's shoe unit is positioned ahead of an instantaneous center (center point when a mass point moving on an arbitrary curve performs rotational motions about a given point far center at a given moment) P1 between the thigh-side link unit (fixed link) 31 and the lower-leg-side link unit (intermediate link) 34.

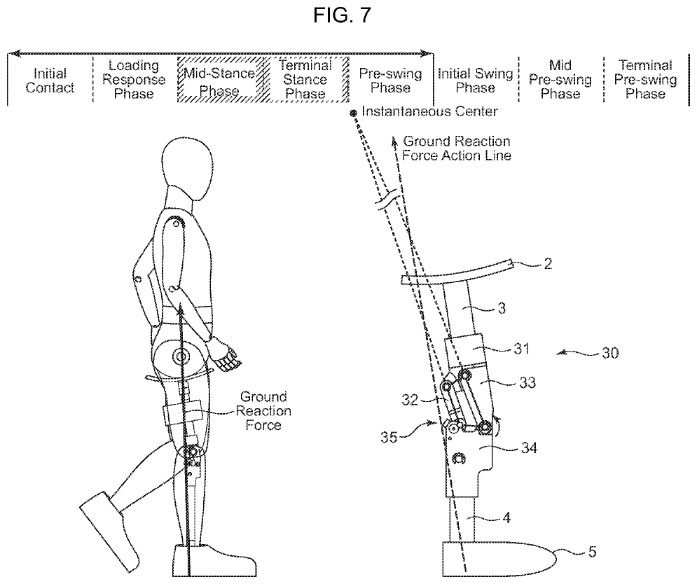

Next, as illustrated in FIG. 7, as the wearer's walking motions proceed and the links of the four-link mechanism of the knee joint connector 30 move backwards, the control unit 40 releases the lock mechanism unit 35 of the knee joint connector 30 in a middle part of the stance phase (from a mid-stance phase to a terminal stance phase). Under this circumstance, at the same time as the line of action F1 of the ground reaction force obtained from the foot sole surface of the wearer's shoe unit 5 is inclined slightly backwards from the vertical direction, the position of the instantaneous center P1 between the thigh-side link unit 31 and the lower-leg-side link unit 34 moves backwards and upwards, thereby increasing the stability of the support for the wearer's body weight.

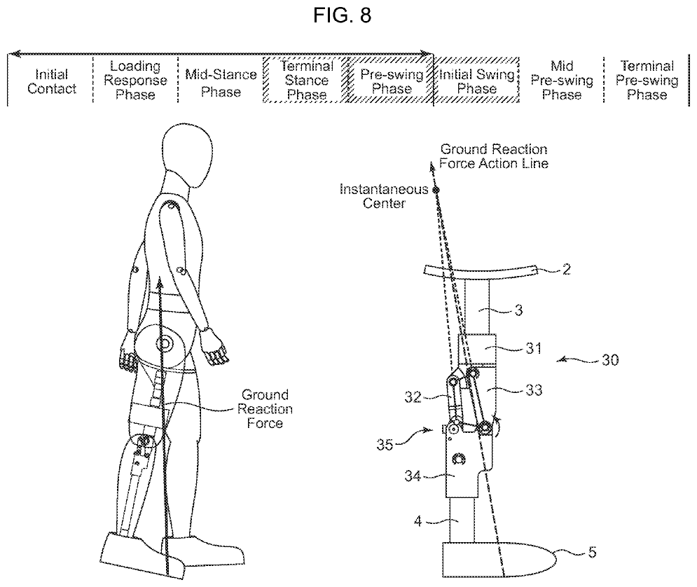

Then, as illustrated in FIG. 8, as the wearer's walking motions proceed and the links of the four-link mechanism of the knee joint connector 30 move forwards, the thigh-side link unit 31 starts to bend relative to the lower-leg-side link unit 34 in an ending part of the stance phase (from the terminal stance phase to a pre-swing phase). Under this circumstance, the line of action F1 of the ground reaction force obtained from the foot sole surface of the wearer's shoe unit moves behind the position of the instantaneous center P1 between the thigh-side link unit 31 and the lower-leg-side link unit 34.

Subsequently, after locking the rotary state of the lock mechanism unit 35 in the bending direction to limit the bending of the wearer's knee joint part to the specified range upon the transition from the swing phase to the stand leg phase of the walking motions, the control unit 40 releases the lock mechanism unit 35 so that the wearer's knee joint part can bend or extend upon the transition from the stance phase to the swing phase, as illustrated in FIGS. 6 to 8 as explained earlier.

Furthermore, with the weight-supported walking assist apparatus 1, the control unit 40 causes the drive unit (rotary drive unit) 20 to generate the motive power according to the wearer's intention upon the transition from the stance phase to the swing phase on the basis of the detection result of the biosignal detection unit 50.

Accordingly, with the weight-supported walking assist apparatus 1, the motions can be assisted while reducing the load on the knee joint part, which is imposed by the wearer's own weight, by reducing the ground reaction force during the stance phase of the walking motions.

### (4) Walking Motion Experiments by Wearer Who Wears Weight-Supported Walking Assist Apparatus

Practically, an explanation will be provided about experiment results where the wearer (a healthy adult male with a body weight of 60 [kg]) walked, five times, the distance of 10 [m] with an allowance of 3 [m] between the 10-m distances with and without the weight-supported walking assist apparatus according to this embodiment on his left leg.

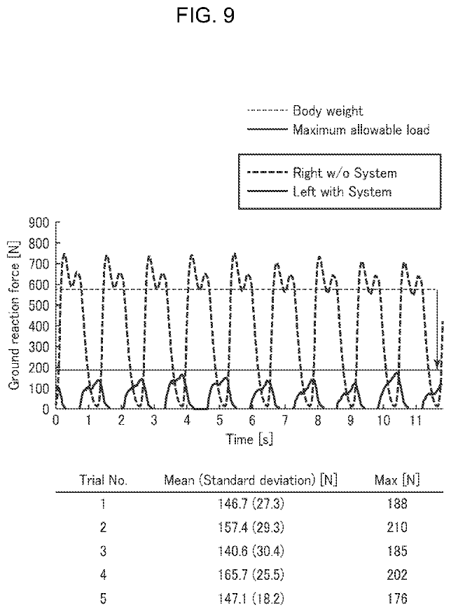

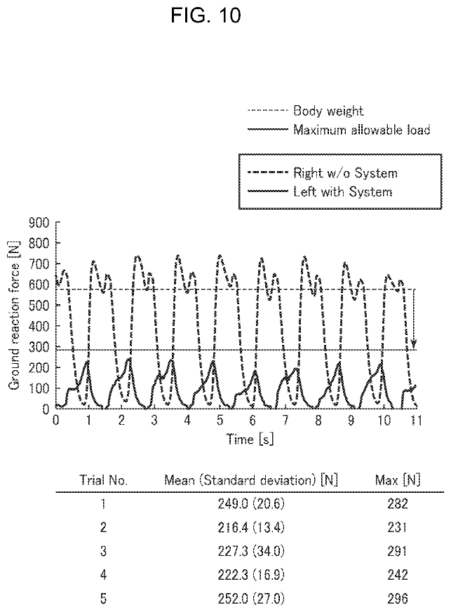

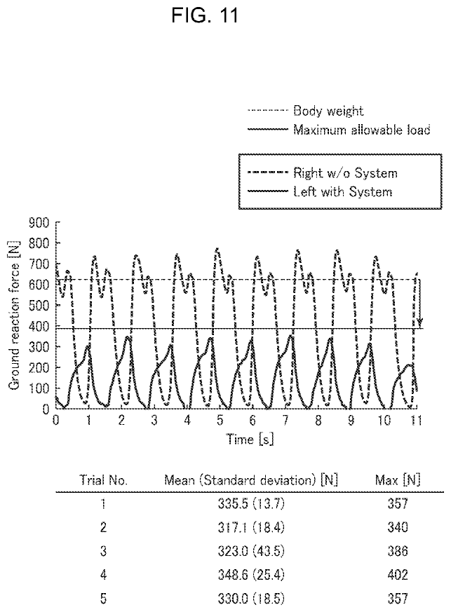

In rehabilitation after a treatment with the regenerative medicine, walking training is firstly performed by applying a load of ⅓ of the wearer's total body weight to the wearer's lower limb and then the load amount is increased according to a state of cell colonization. So, the walking motions were checked when the load applied to the wearer's lower limb on the wearing side was set to a ⅓ (FIG. 9), a ½ (FIG. 10), and ⅔ (FIG. 11) of the wearer's total body weight, respectively.

As illustrated in FIG. 9, when the load applied to the left leg (with device) wearing the apparatus was adjusted to a ⅓ of the total body weight while the right leg (w/o device) did not wear the weight-supported walking assist apparatus 1, the wearer actually performed the walking motions and the detection results (pressure distribution to the wearer's foot sole parts) of the right and left ground reaction force sensors 42 were measured; and as a result, it was confirmed from the results of five trials that the load of the lower limb wearing the weight-supported walking assist apparatus was mostly equal to or less than an allowable maximum load value (⅓ of the total body weight).

Similarly in FIG. 10, when the load applied to the left leg (with device) wearing the apparatus was adjusted to a ½ of the total body weight while the right leg (w/o device) did not wear the weight-supported walking assist apparatus 1, the wearer actually performed the walking motions and the detection results (pressure distribution to the wearer's foot sole parts) of the right and left ground reaction force sensors 42 were measured; and as a result, it was confirmed from the results of five trials that the load of the lower limb wearing the weight-supported walking assist apparatus was mostly equal to or less than the allowable maximum load value (½ of the total body weight).

Similarly in FIG. 11, when the load applied to the left leg (with device) wearing the apparatus was adjusted to ⅔ of the total body weight while the right leg (w/o device) did not wear the weight-supported walking assist apparatus 1, the wearer actually performed the walking motions and the detection results (pressure distribution to the wearer's foot sole parts) of the right and left ground reaction force sensors 42 were measured; and as a result, it was confirmed from the results of five trials that the load of the lower limb wearing the weight-supported walking assist apparatus 1 was mostly equal to or less than the allowable maximum load value (⅔ of the total body weight).

According to the trial results of the three types of partial loads in FIG. 9 to FIG. 11 as described above, it was confirmed that the load on the lower limb wearing the weight-supported walking assist apparatus 1 was equal to or less than the allowable maximum load value in 96% of all the trials.

### (5) Other Embodiments

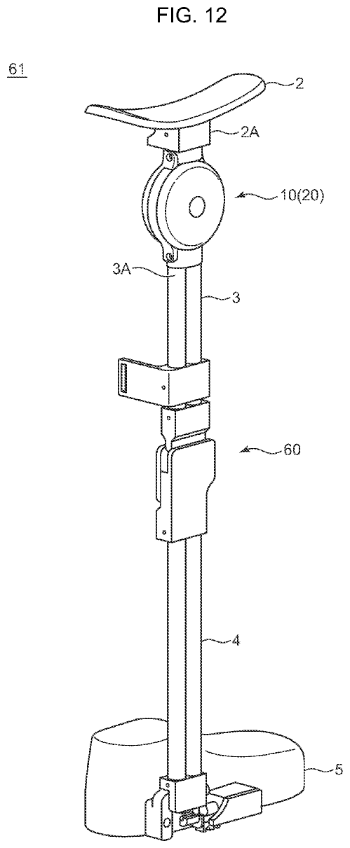

Incidentally, this embodiment has described as explained earlier the case where the knee joint connector having the closed-loop structure consisting of the four-link mechanism is applied to the weight-supported walking assist apparatus 1; however, the present invention is not limited to this example and a weight-supported walking assist apparatus 61 having a knee joint connector 60 of a joint structure with a lock mechanism as illustrated in FIG. 12, in which the same reference numerals as those in FIG. 1 are assigned to parts corresponding to those in FIG. 1, may be applied.

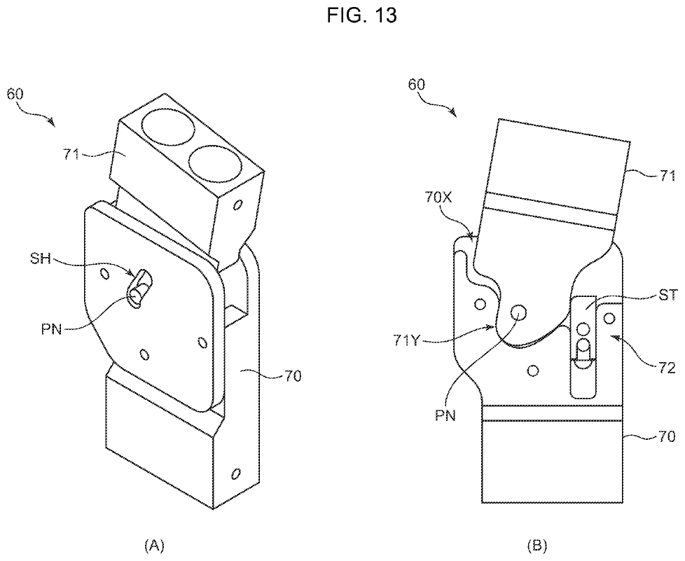

With the knee joint connector 60 as illustrated in FIG. 13(A), a lower-leg-side part unit 70 connected to an end of the lower leg frame 4 engages with a thigh-side part unit 71 connected to an end of the thigh frame 3 so that they can rotate and move within a specified range.

FIG. 13(B) illustrates an internal structure of the knee joint connector 60. As illustrated in this FIG. 13(B), a protrusion 71Y of the thigh-side part unit 71 fits, in a freely movable manner, in a recess 70X in the lower-leg-side part unit 70 and they engage with each other in such a manner that a pin PN formed on the protrusion 71Y can slide and move along a slide hole SH (FIG. 13(A)) formed in the recess 70X.

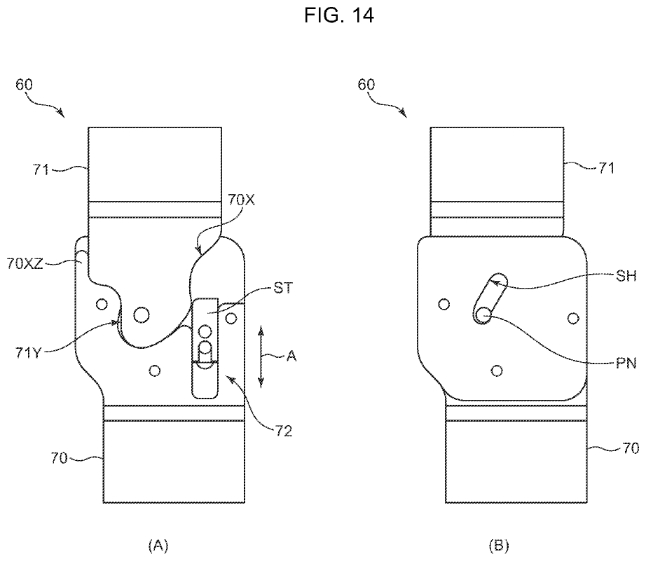

Referring to FIG. 14(A), a locking protrusion 70XZ is formed at an end of the recess 70X in the lower-leg-side part unit 70; and as a root part of the protrusion 71Y of the thigh-side part unit 71 enters into contact with the locking protrusion 70XZ, movability in its contact direction becomes impossible and is thereby limited. Under this circumstance, it is designed as illustrated in FIG. 14(B) so that the pin PN of the thigh-side part unit 71 enters into contact with a lower end of the slide hole SH in the lower-leg-side part unit 70.

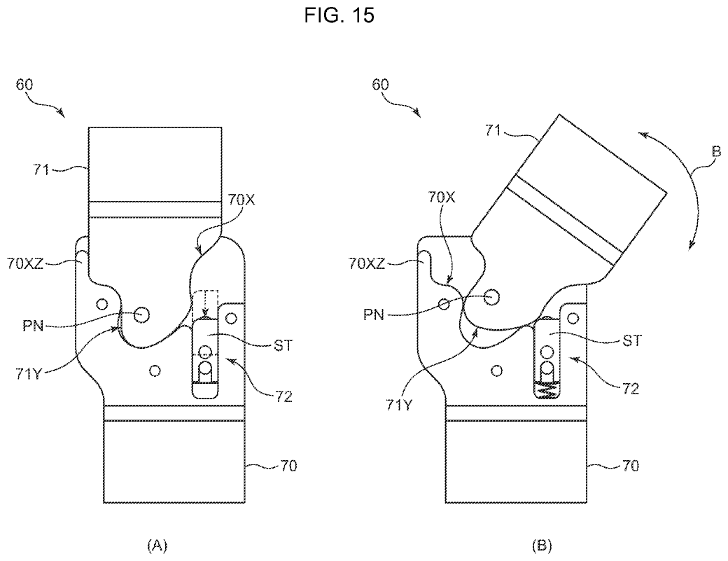

A lock mechanism unit 72 in which a stopper ST of a substantially rectangular parallelepiped shape is slidable in vertical directions (linear directions indicated with arrows A) as operated by an electromagnetic solenoid is provided in the recess 70X in the lower-leg-side part unit 70. With this lock mechanism unit 72, when the stopper ST is positioned at the lower end as illustrated in FIG. 15(A), the thigh-side part unit 71 can rotate in bending directions relative to the lower-leg-side part unit 70 (rotational directions indicated with arrows B) as illustrated in FIG. 15(B); and on the other hand, when the stopper ST is located at the upper end, the position of the thigh-side part unit 71 is fixed in a state with a specified angle relative to the lower-leg-side part unit 70 (FIGS. 13(A) and 13(B) as described earlier).

With this weight-supported walking assist apparatus 61, when the wearer performs the walking motions in a state with their buttocks supported by the seat unit 2, the control unit 40 (the same configuration as illustrated in FIG. 4 is applied) causes the stopper ST of the lock mechanism unit 72 to be positioned at the upper end in the beginning part of the stance phase of the walking motions (from the initial contact to the loading response phase), thereby limiting the bending state of the knee joint connector 60 and preventing the wearer's knee buckling.

Next, as the wearer's walking motions proceed to the middle part of the stance phase (from the mid-stance phase to the middle of the terminal stance phase), the root part of the protrusion 71Y of the thigh-side part unit 71 enters into contact with the locking protrusion 70XZ in the recess 70X in the lower-leg-side part unit 70, thereby making it possible for the knee joint connector 60 to enter into an extended state and stably support the wearer's body weight.

Then, as the wearer's walking motions proceed to the ending part of the stance phase (from the terminal stance phase to the pre-swing phase), the control unit causes the stopper ST of the lock mechanism unit 72 to be positioned at the lower end, so that the thigh frame 3 starts to bend relative to the lower leg frame 4.

Subsequently, upon the transition from the swing phase to the stance phase of the walking motions, the control unit 40 causes the stopper ST of the lock mechanism unit 72 to be positioned at the upper end so as to limit bending of the wearer's knee joint part to a specified range and thereby fixes the rotary state; and after that, upon the transition from the stance phase to the swing phase, the control unit 40 causes the stopper ST of the lock mechanism unit 72 to be positioned at the lower end so that the wearer's knee joint part can bend or extend.

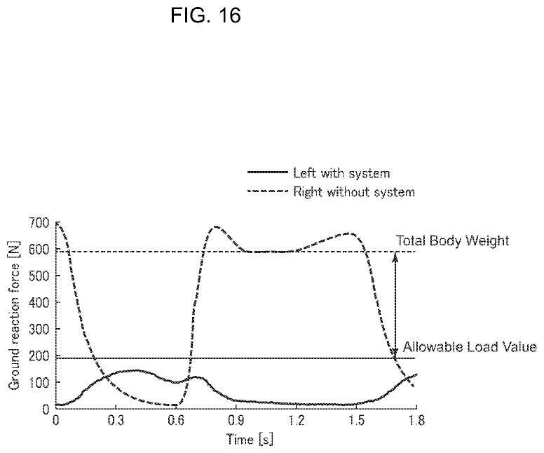

Also, regarding this weight-supported walking assist apparatus 61, experiments similar to the aforementioned walking motion experiments were conducted. FIG. 16 illustrates the relationship between a load value of one gait cycle by the wearer and movement control of the stopper ST of the lock mechanism unit 72. As a result, it was successfully confirmed that when the wearer's leg which does not wear the apparatus contacts the ground, the stopper ST of the lock mechanism unit 72 operates (moves its position to the upper end) and the wearer thereby can walk.

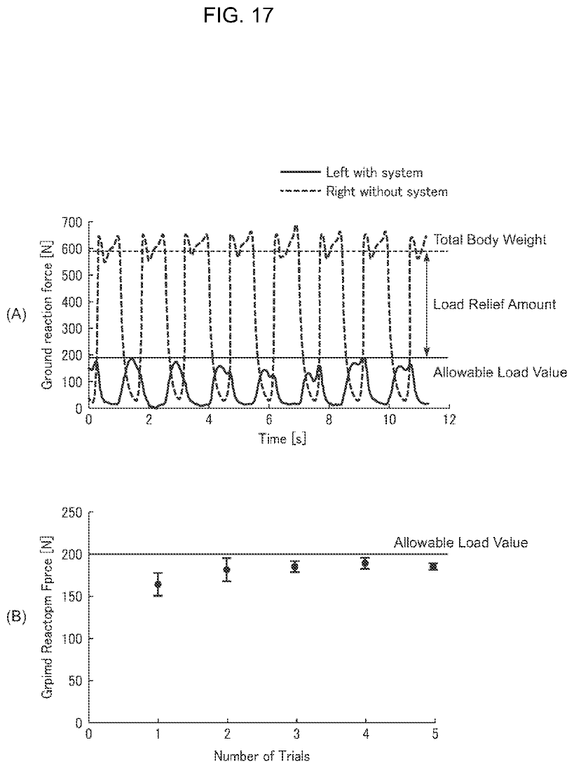

Then, according to load values on right and left lower limbs in a 10 [m] walking test as indicated in FIG. 17(A) and peak values of the load values on the lower limb wearing the weight-supported walking assist apparatus 61 as indicated in FIG. 17(B), it was also successfully confirmed that the load on the lower limb wearing the weight-supported walking assist apparatus 61 is 196 [N] and does not exceed an allowable maximum load value. Incidentally, an average and standard error of peak values of respective trials was 181±12.8 [N].

Moreover, this embodiment has described the case where the insole-type ground reaction force sensor 42 is provided at soles of the right and left shoe units 5 and the reaction force to the load imposed on the wearer's foot sole surfaces (pressure distribution to the foot sole parts) is detected; however, the present invention is not limited to this example and, in addition to the ground reaction force sensor 42, a seat surface reaction force sensor (which is not illustrated in the drawing) may be also provided at the seat unit.

Specifically, the seat surface reaction force sensor which is mounted in the seat unit and detects the pressure distribution to the wearer's buttocks is further included and the control unit 40 controls the drive unit (rotation drive unit) 20 to cause the shoe unit to not contact the walking surface during the swing phase of the walking motions on the basis of the detection result of the biosignal detection unit 50 and the detection result of the seat surface reaction force sensor.

As a result, the weight-supported walking assist apparatus 1 can assist the motions by adjusting the weight burden on the knee joint part, which is imposed by the wearer's own weight, to the optimum state with high accuracy by reducing the ground reaction force during the stance phase of the walking motions on the basis of not only the pressure distribution to the wearer's foot sole parts, but also the pressure distribution to the wearer's buttocks.

### REFERENCE SIGNS LIST

1, 61: weight-supported walking assist apparatus
2: seat unit
3: thigh frame
4: lower leg frame
5: shoe unit
7, 8: cuff
10: hip joint connector
20: drive unit (rotary drive unit)
21: actuator
22 actuator control unit
23: decelerator
30, 60: knee joint connector
31: thigh-side link unit (fixed link)
32: bending link unit (driver)
33: patella link unit (follower)
34: lower-leg-side link unit (intermediate link)
35, 72: lock mechanism unit
40: control unit
41: data storage unit
42: ground reaction force sensor
43: ground reaction force control unit
44: conversion unit
45: LPF
50: biosignal detection unit
70 lower-leg-side part unit
71: thigh-side part unit

1. A weight-supported walking assist apparatus comprising:
a seat unit that supports buttocks of a wearer;
a thigh frame and a lower leg frame that are located along inside of a leg part of the wearer;
a hip joint connector that couples an underside of the seat unit with one end of the thigh frame and is rotatable in accordance with motions of a hip joint part of the wearer;
a rotary drive unit that is provided in the hip joint connector and drives the thigh frame relative to the seat unit in a rotation direction of the hip joint part;
a knee joint connector that couples another end of the thigh frame with one end of the lower leg frame and is rotatable in accordance with motions of a knee joint part of the wearer;
a lock mechanism unit for locking or releasing a rotary state of the knee joint connector;
shoe units that are for right and left foot parts of the wearer to wear and either one of which is joined to another end of the lower leg frame;
a ground reaction force sensor that is attached to each of the right and left shoe units and detects pressure distribution to each foot sole surface of the wearer;
a biosignal detection unit that is attached to a thigh part of the wearer on a side where the thigh frame is located, and detects a biosignal caused by walking motions of the wearer;
a gait synchronization calculation unit that calculates a gait cycle of the wearer based on a detection result of the ground reaction force sensor; and
a control unit that locks a rotary state of the lock mechanism unit in a bending direction so as to limit bending of the knee joint part of the wearer to a specified range upon a transition from a swing phase to a stance phase of the walking motions on the basis of a calculation result of the gait synchronization calculation unit, while releasing the lock mechanism unit so that the knee joint part of the wearer can bend or extend upon a transition from the stance phase to the swing phase,
wherein the control unit causes the rotary drive unit to generate motive power according to the wearer's intention upon the transition from the stance phase to the swing phase on the basis of a detection result of the biosignal detection unit.

2. The weight-supported walking assist apparatus according to claim 1,
wherein the control unit adjusts a fixed range of the rotary state of the lock mechanism unit so that a load amount on the knee joint part of the wearer will increase in accordance with a transition state in a corrective direction in order to improve symptoms of the knee joint part of the wearer.

3. The weight-supported walking assist apparatus according to claim 1, further comprising a seat surface reaction force sensor that is mounted in the seat unit and detects pressure distribution to the buttocks of the wearer,
wherein the control unit controls the rotation drive unit so that the shoe unit will not contact a walking surface during the swing phase of the walking motions on the basis of the detection result of the biosignal detection unit and the detection result of the seat surface reaction force sensor.

4. A method for controlling a weight-supported walking assist apparatus, wherein while buttocks of a wearer are supported by a seat unit, a thigh frame and a lower leg frame are located along inside of a leg part of the wearer, shoe units either one of which is joined to another end of the lower leg frame are mounted to right and left foot parts of the wearer, and furthermore a hip joint connector that couples an underside of the seat unit with one end of the thigh frame is made rotatable in accordance with motions of a hip joint part of the wearer and a knee joint connector that couples another end of the thigh frame with one end of the lower leg frame is made rotatable in accordance with motions of a knee joint part of the wearer; and
wherein the hip joint connector is provided with a rotary drive unit that drives the thigh frame relative to the seat unit in a rotation direction of the hip joint part and is also provided with a lock mechanism unit for locking or releasing a rotary state of the knee joint connector,
the method for controlling the weight-supported walking assist apparatus, comprising:
a first step of detecting pressure distribution to respective foot sole parts of the wearer at the right and left shoe units;
a second step of calculating a gait cycle of the wearer based on a detection result of the first step;
a third step of locking a rotary state of the lock mechanism unit in a bending direction so as to limit bending of the knee joint part of the wearer to a specified range upon a transition from a swing phase to a stance phase of walking motions on the basis of a calculation result of the second step, while releasing the lock mechanism unit so that the knee joint part of the wearer can bend or extend upon a transition from the stance phase to the swing phase;
a fourth step of detecting a biosignal caused by the walking motions of the wearer at a thigh part of the wearer on a side where the thigh frame is located; and
a fifth step of causing the rotary drive unit to generate motive power according to the wearer's intention upon the transition from the stance phase to the swing phase in the third step on the basis of a detection result of the fourth step.

5. The method for controlling the weight-supported walking assist apparatus according to claim 4,
wherein in the third step, a fixed range of the rotary state of the lock mechanism unit is adjusted so that a load amount on the knee joint part of the wearer will increase in accordance with a transition state in a corrective direction in order to improve symptoms of the knee joint part of the wearer.

6. The method for controlling the weight-supported walking assist apparatus according to claim 4,
further comprising a sixth step of detecting pressure distribution to the buttocks of the wearer at the seat unit,
wherein in the fifth step, the rotation drive unit is controlled so that the shoe unit will not contact a walking surface during the swing phase of the walking motions on the basis of the detection result of the fourth step and the detection result of the sixth step.
